(19) United States
(12) Patent Application Publication
(10) Pub. No.: US 2026/0191377 A1
(43) Pub. Date: Jul. 9, 2026

(54) SYSTEMS AND METHODS FOR ACTIVE SUSPENSION FOR A ROBOTIC CLEANING DEVICE

(71) Applicant: SharkNinja Operating LLC, Needham, MA (US)

(72) Inventors: Derek Anguita Lessard, Dorchester, MA (US); Jacob Marc L’Heureux, South Boston, MA (US); Scott C. Teuscher, Advance, NC (US)

(21) Appl. No.: 19/129,006

(22) PCT Filed: Nov. 10, 2023
(86) PCT No.: PCT/US2023/037163

§ 371 Date: May 10, 2025

Related U.S. Application Data
(60) Provisional application No. 63/424,754, filed on Nov. 11, 2022.
(60) Provisional application No. 63/424,740, filed on Nov. 11, 2022.
(60) Provisional application No. 63/532,266, filed on Aug. 11, 2023.
(60) Provisional application No. 63/532,269, filed on Aug. 11, 2023.

(51) Int. Cl. A47L 9/00; A47L 9/04; A47L 9/28

(52) U.S. Cl. CPC A47L 9/0072; A47L 9/009; A47L 9/0411; A47L 9/0477; A47L 9/0494; A47L 9/2821; A47L 9/2826; A47L 9/2831; A47L 9/2852; A47L 2201/04; A47L 2201/06

(57) ABSTRACT

A robotic cleaner including a chassis with an upper portion and a lower portion and one or more wheel assemblies disposed on the lower portion of the chassis. Each of the one or more wheel assemblies including an arm having a first end pivotally mounted to the chassis and a second end opposite the first end and a wheel rotatably coupled to the second end of the arm. The wheel is configured to contact a target surface. The robotic cleaner includes one or more sensors configured to sense characteristics of the robotic cleaner's surroundings, and an active suspension system configured to rotate the arm about the first end in response to the sensed characteristics of the robotic cleaner's surroundings to optimize suction with respect to the target surface by independently adjusting one or more ride height dimensions of the robotic cleaning device.

### CROSS-REFERENCE TO RELATED APPLICATION

This application is a 35 U.S.C. § 371 entry of PCT/US 2023/037163, filed Nov. 10, 2023, which claims the benefit of U.S. Provisional Application No. 63/424,754, filed Nov. 11, 2022; U.S. Provisional Application No. 63/424,740, filed Nov. 11, 2022; U.S. Provisional Application No. 63/532,266, filed Aug. 11, 2023 and U.S. Provisional Application No. 63/532,269, filed Aug. 11, 2023, the disclosures of which are incorporated by reference herein in their entirety.

### TECHNICAL FIELD

The present disclosure relates generally to the field of robotic cleaners and, more particularly, to suspension systems in robotic cleaners.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Within the field of robotic cleaning devices, various cleaning functionalities may be implemented to address a range of cleaning needs. For example, some robotic cleaning devices may include functionality for vacuum cleaning, wet cleaning, agitators brushes, etc. Robotic cleaners may operate in a variety of environments that may include varying terrain, floor types, debris, and other obstacles. Because many robotic cleaning devices may operate in autonomous and/or semi-autonomous modes, a need exists for the robotic cleaning devices to make automatic adjustments to maintain functionality in a wide variety of environments.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes a robotic cleaner comprising a chassis including an upper portion and a lower portion and one or more wheel assemblies disposed on the lower portion of the chassis. In some embodiments, each of the one or more wheel assemblies may include an arm having a first end pivotally mounted to the chassis and a second end opposite the first end, and a wheel rotatably coupled to the second end of the arm. The wheel may be configured to contact a target surface. The robotic cleaner may include one or more sensors configured to sense characteristics of the robotic cleaner's surroundings. The robotic cleaner may also include an active suspension system configured to rotate the arm about the first end in response to the sensed characteristics of the robotic cleaner's surroundings, thereby moving the wheel away from the chassis.

In another embodiment, the disclosure describes an active suspension system for a robotic cleaning device. The active suspension system may include a wheel assembly including an arm having a first end pivotally mounted to a chassis of the robotic cleaning device and a second end opposite the first end, and a wheel rotatably coupled to the second end of the arm. The wheel may be configured to contact a target surface. The active suspension system may include at least one cam in slidable contact with the arm, and at least one cam motor mounted to the chassis of the robotic cleaning device. In some embodiments, the at least one motor may be configured to selectively rotate the at least one cam. In some embodiments, the at least one cam may be configured to push the second end of the arm away from the chassis when the at least one cam motor rotates the at least one cam.

In another embodiment, the disclosure describes processor-implemented method of controlling a robotic cleaning device. The method may include processor-executable instructions for sensing, via one or more sensors, one or more characteristics of an environment surrounding the robotic cleaning device. The method may include identifying, via one or more processors and based on the one or more sensed characteristics, at least one object in the environment and determining that the at least one object is located in a path of the robotic cleaning device. The method may include determining, via the one or more processors and based on the sensed one or more characteristics, at least one dimension of the at least one object. The method may include activating an active suspension system to raise the distance between a chassis of the robotic cleaning device and a target surface based on the determined at least one dimension.

### BRIEF DESCRIPTION OF THE DRAWINGS

Non-limiting and non-exhaustive embodiments are described in reference to the following drawings. The components in the figures are not necessarily to scale, emphasis instead being placed upon illustrating the principles of the disclosure. In the drawings, like reference numerals refer to like parts through all the various figures unless otherwise specified.

For a better understanding of the present disclosure, a reference will be made to the following detailed description, which is to be read in association with the accompanying drawings, wherein:

FIG. 1A is a partial cross-sectional side view of an embodiment of a robotic cleaner in accordance with the disclosure;

FIG. 1B is a front view of the robotic cleaner of FIG. 1A;

FIG. 2A is a top perspective view of the robotic cleaner of FIG. 1A;

FIG. 2B is an exploded view of the robotic cleaner of FIG. 1A;

FIG. 3A is a partial cross-sectional view of the robotic cleaner of FIG. 1A showing an embodiment of an active suspension system in a first position in accordance with the disclosure;

FIG. 3B is a partial cross-sectional view of the robotic cleaner of FIG. 1A showing the active suspension system of FIG. 3A in a second position;

FIG. 4A is a detailed view of the active suspension system of FIG. 3A in the first position;

FIG. 4B is a detailed view of the active suspension system of FIG. 3B in the second position;

FIG. 5 is a side view of another embodiment of an active suspension system in accordance with the disclosure;

FIG. 6 is a flow chart of an embodiment of a method for controlling an active suspension system of a robotic cleaner in accordance with the disclosure;

FIG. 7 is a flow chart of another embodiment of a method for controlling an active suspension system of a robotic cleaner in accordance with the disclosure;

FIG. 8 is a top cross-sectional view of another embodiment of an active suspension system in accordance with the disclosure;

FIG. 9 is a top cross-sectional view of another embodiment of an active suspension system in accordance with the disclosure;

FIG. 10 is a top cross-sectional view of another embodiment of an active suspension system in accordance with the disclosure; and

FIG. 11 is a flow chart of another embodiment of a method for controlling an active suspension system of a robotic cleaner in accordance with the disclosure.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. This disclosure may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and includes plural references. The meaning of “in” includes “in” and “on.”

The disclosure describes, in some embodiments, an autonomous or semi-autonomous robot that may be configured to vacuum, wet clean, or otherwise clean floors, carpets, and/or other target surfaces in homes or other appropriate locations. In some embodiments, autonomous cleaning robots consistent with the disclosure may include a chassis and a transport drive system configured to autonomously transport cleaning elements over the target surface. The robot may be supported on the target surface by a plurality of wheels in rolling contact with the target surface, and the robot may include controls and drive elements configured to direct the robot to generally traverse the target surface in one or more directions. In some embodiments, the robot may include a drive device controlled by a controller and powered by one or more motors for performing autonomous movement over the target surface.

In some embodiments, the cleaning robot may include one or more cleaning modules. In embodiments with multiple cleaning modules, the cleaning modules may operate separately or in coordination. In some embodiments, the modular cleaning robot may include a dry cleaning module that may be configured to collect dry debris from the target surface and a wet cleaning module that may be configured to perform wet cleaning by applying a liquid, such as a cleaning fluid, onto a cleaning pad and using the cleaning pad to scrub the target surface. The surface cleaning robot may also include at least two containers or compartments that may store debris collected by the first cleaning module and to store cleaning fluid that may be used by the second cleaning module.

In some embodiments, the cleaning robot may include an active suspension system that may be configured to adjust the robot's ride height. The active suspension system may provide various benefits to the robot's performance, such as increased cleaning capabilities, efficiencies, and improved energy efficiency and/or battery life. For example, in some embodiments, the active suspension system may help optimize ride height to improve suction/sealing with a target surface and/or to maintain desired contact with the target surface and rotation speeds for agitator brushes. In some embodiments, a control method may include maintaining a desired, predetermined, or calculated engagement depth or interference distance between cleaning robot components (e.g., agitating members such as brushes) and a target surface. In some embodiments, a control method may include maintaining a substantially constant torque load on cleaning robot components such as an agitating motor or brush roll motor. Additionally, the active suspension system may provide improved mobility for the cleaning robot, such as by improving or optimizing ride height over target surfaces with varying properties and/or providing improved ability to travel over thresholds, cables, or other environmental obstacles. In some embodiments, the active suspension system may also provide for selectively lifting a cleaning pad (or other robot features) to reduce or prevent the interference with the target surface when not desired. For example, in some embodiments, the active suspension system may provide for lifting a soiled cleaning pad clear of a target surface, such as a rug, so as to reduce or eliminate transfer the soiling material to the target surface.

In some embodiments, the active suspension system described herein may provide hard stops to wheel modules of the robot that may allow the robot to vary ride height over different types of target surfaces. In some embodiments, this may be achieved without changing other features of the robot's suspension system. For example, in some embodiments, the active suspension system may provide tighter seals to certain target surfaces (e.g., bare floors, low-pile carpet, etc.) while still providing the ability to clear obstacles. In some embodiments, the target surface conditions may be determined by one or more sensors that may inform the optimal ride height for the given conditions and desired cleaning performance.

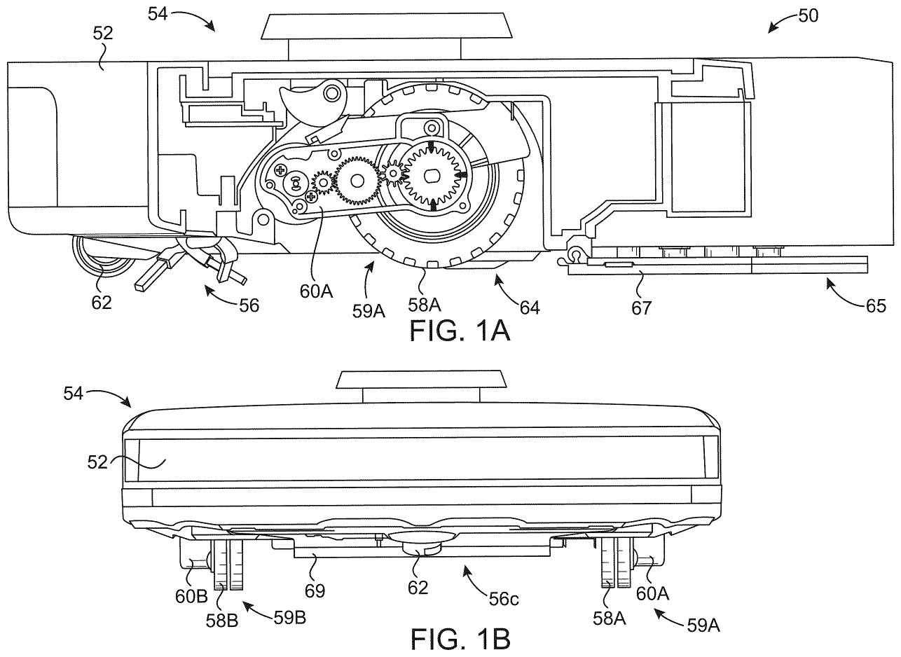

FIGS. 1A and 1B embodiments of a cleaning robot 50 that may include the active suspension system described herein. The cleaning robot 50 may include a generally round housing or chassis 52 that may have an upper portion 54 and a lower portion 56. In some embodiments, the upper portion 54 may include a user interface that may be used to initiate cleaning or other operations and/or provide indications of robot status (e.g., mode, battery life, errors, etc.). The cleaning robot 50 may include one or more driven wheel assemblies 59A, 59B that may include drive wheels 58A, 58B. The robot 50 may also include one or more caster wheels 62 coupled to the lower portion 56 of the chassis 52. In some embodiments, the wheels 58A, 58B may be independently rotatable about associated rotational axes and may be coupled to respective drive motors contained within each driven wheel assembly 59A, 59B. As such, in some embodiments, each wheel 58A, 58B may generally be described as being independently driven. In some embodiments, both wheels 58A, 58B may be driven with a single drive motor that may distribute power to the wheels via one or more drive shaft and/or differential, or the wheels may be driven by a separate motor (e.g., suction motor) having power split for various different robot components. In some embodiments, the cleaning robot 50 may be autonomously steered or controlled to maneuver over a target surface such as by drive signals from one or more controllers disposed on a control board on the robot. The drive signals may maneuver the cleaning robot 50 by, for example, adjusting the rotational speed of one of the plurality of wheels 58A, 58B relative to the other of the plurality of wheels.

Each wheel assembly 59A, 59B may include an arm 60A, 60B and a wheel 58A, 58B. Each arm 60A, 60B may have a proximate end rotatably coupled to the lower portion 56 of the chassis 52 or to a static portion of the wheel assembly. Each wheel 58A, 58B may be rotatably coupled to a distal end of each respective arm 60A, 60B substantially opposite the proximate end. In some embodiments, each wheel assembly 59A, 59B may include a drive motor that may be coupled to the arm 60A, 60B. In some embodiments, each wheel assembly 59A, B may also include one or more gears that may be configured to transmit power from each drive motor to each respective wheel 58A, 58B. In some embodiments, each proximate end of each respective arm 60A, 60B may be rotatable about the chassis 52 to raise and/or lower each respective wheel 58A, 58B. As described in more detail below, the active suspension system 100 may cause each proximate end of each respective arm 60A, 60B to pivot and, lowering each wheel 58A, 58B, and thus selectively raising and/or lowering the chassis 52 with respect to the floor or other target surface.

In some embodiments, the cleaning robot 50 may also include a vacuum module 64, which may include a suction conduit 69, a dust cup, and a suction motor, among other components. The suction conduit 69 may be disposed on the lower portion 56 of the chassis 52 in opposed facing relationship to the floor or other target surface and may be fluidly coupled to the dust cup and the suction motor. In some embodiments, the suction motor may cause debris from the target surface to be suctioned into the suction conduit 69 and deposited into the dust cup for later disposal. An air exhaust port may be fluidly coupled to the suction motor. In various embodiments, the air exhaust port may be configured to prevent undesirable debris agitation, to direct debris, or to dry cleaning fluid.

In some embodiments, the robotic cleaner 50 may include a wet cleaning module 65 that may be removably affixed to the chassis 52. The wet cleaning module 65 may include a cleaning fluid tank and a wet cleaning pad 67. In some embodiments, as the cleaning robot 50 may travel across a floor or other target surface, the suction conduit 69 connected to the suction motor may collect dry debris from the floor while a liquid applicator of the wet cleaning module 65 may apply a cleaning fluid onto the wet cleaning pad 67. In some embodiments, the wet cleaning pad 67 may be raised and/or lowered with respect to the target surface, such as via raising or lowering the wheels 58A, B with the active suspension system disclosed herein.

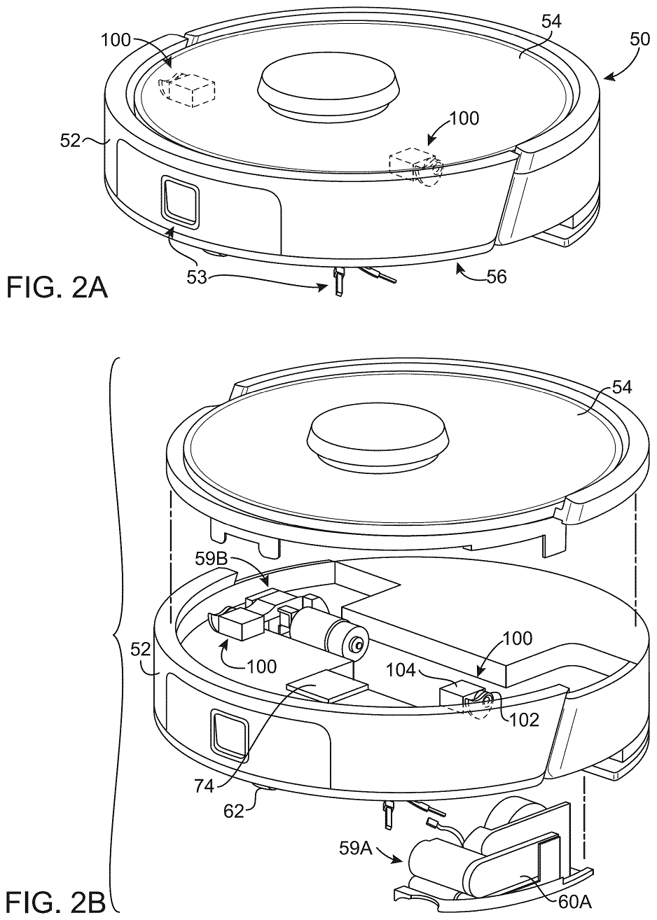

FIGS. 2A and 2B shows an embodiment of the cleaning robot 50 including an active suspension system 100. The active suspension system 100 may take various forms to raise and/or lower the wheels 58A, 58B with respect to chassis 52 of the cleaning robot 50. In some embodiments, the active suspension system 100 may be controlled by one or more controllers 74 that may be disposed in the wheel assembly 59A, 59B or elsewhere in the cleaning robot 50. In some embodiments, the controller may be a proportional-integral-derivative (PID) controller, or may another type of suitable controlling device. In some embodiments, the controller (e.g., PID controller) may be partially or entirely software-based, and may not require a separate controller device connected to the active suspension system. In some embodiments, the active suspension system may include a closed-loop controller without any direct feedback. For example, such a controller may control the limits on wheel travel (e.g., up or down) without actually directly measuring the wheel position. In some embodiments, the controller (e.g., PID) inputs may be indirect measurements, such as brush roll current or cliff sensor data. The controller may be in electronic communication with one or more sensors 53 on the cleaning robot 50 that may provide information about the cleaning robot's environment, location, obstacles, and/or the properties of the floor or other target surface. In some embodiments, those sensors 53 may include proximity sensors, optical sensors, sonar, LIDAR, infrared (IR) sensors, ultrasonic sensors, 2D and/or 3D cameras, photosensors, etc. In some embodiments, one or more laser beams emitted from lasers disposed on the robot 50 may continuously or periodically scan the robot's surroundings and any returned reflections (visible or otherwise) may be detected by a camera disposed on the robot. Using a plurality of laser lines over time, the camera's detection of the laser returns may be constructed into a point cloud of laser returns from an obstacle or other environmental feature. The point cloud may be analyzed to determine characteristics of the detected object, such as physical dimensions (e.g., height), which may be used to determine desired positioning for the active suspension system 100.

In some embodiments, operation of other components of the cleaning robot 50 in electronic communication with the controller may provide additional information about the robot's environment, obstacles, floor conditions, or performance. In some embodiments, the controller may use such inputs to determine appropriate responsive actions by the active suspension system 100. For example, the controller may determine properties of the cleaning robot's 50 surroundings by monitoring electrical current, voltage, and/power usage by agitators or brush rolls in the vacuum module 64 over time. Depending on the brush roll's current draw, the controller may determine whether the brush roll may be encountering too much or too little resistance and raise/lower the wheels accordingly. In another example, the controller may use current or other power usage information from a suction motor to determine whether to raise/lower the wheels via the active suspension system to optimize the vacuum's seal and/or suction performance. Those of skill in the art will recognize that other inputs may also be used or taken into account when determining and positioning the wheel height and corresponding chassis clearance of the cleaning robot to most effectively perform a cleaning task or other activity.

### Cam System

The FIGS. 2-5 show embodiments of an active suspension system 100 of the cleaning robot 50 wherein each wheel assembly 59A, 59B may include a rotatable cam 102 configured to be selectively driven by a cam motor 104 to raise/lower the wheels 58A, 58B with respect to the chassis 52 of the cleaning robot 50. In some embodiments, the wheel assembly 59 may include passive suspension system that may include a spring 71 to a shock absorber. The spring 71 may dampen movements of the chassis 52 as the wheel 58 encounters debris or uneven surfaces. In some embodiments, the cam 102 of the active suspension system 100 may rotate between two or more positions to provide a movable hard stop that may allow the cleaning robot 50 to change how high the chassis 52 rides without changing other basic functionality of the cleaning robot's passive suspension system.

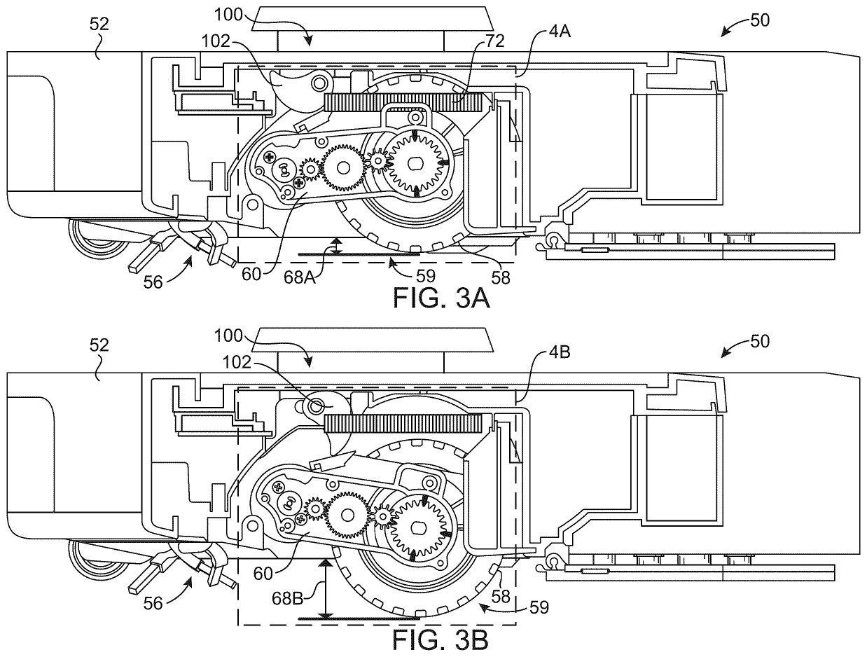

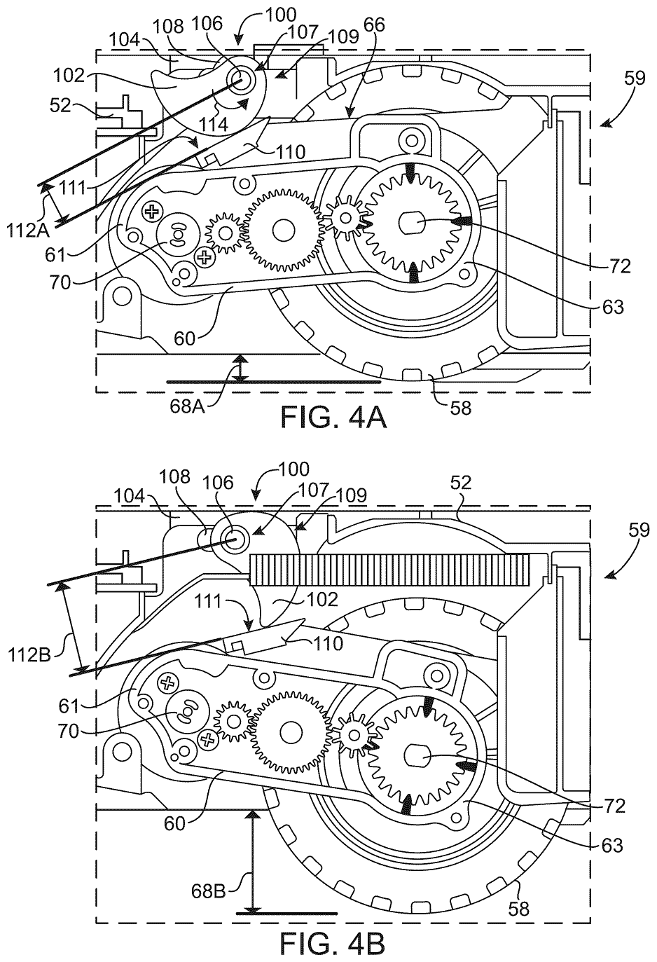

FIGS. 3A and 3B show an embodiment of how the active suspension system 100 may be a part of or may interact with the wheel assembly 59A and/or the passive suspension system, while FIGS. 4A and 4B show a more detailed depiction of the active suspension system. For ease of explanation, the description of FIGS. 3-5 refers to a wheel assembly 59 that could refer to any of wheel assemblies 59A, 59B, etc., and their respective components. In some embodiments, each wheel assembly 59 may include an arm 60 having a proximate end 61 and a distal end 63. The proximate end 61 of the arm 60 may be pivotally coupled to the chassis 52 via a pivot joint 70, and the distal end 63 may be rotatably coupled to the wheel 58 via a wheel axle 72. In some embodiments, the wheel 58 and axle 72 may be driven by one or more drive motors via a gear train 57 that may be disposed on the arm 60.

As mentioned above, in some embodiments, the active suspension system 100 may selectively move a hard stop for the wheel 58 between a first position shown in FIGS. 3A and 4A, and a second position, shown in FIGS. 3B and 4B. It is contemplated that, in some embodiments, the active suspension system 100 may move between the first position and the second position and may also hold the wheel in virtually any position between the first and second positions. Movement by the active suspension system 100 between the first position and the second position may increase and/or decrease a clearance height between the floor and the chassis 52. For example, the chassis 52 may have a first clearance height 68A when the active suspension system 100 is in the first position (FIGS. 3A and 4A), and may have a second clearance height 68B when the active suspension system is in the second position (FIGS. 3B and 4B), which may be greater than the first clearance height. In some embodiments, as shown in FIG. 4A, the active suspension system 100 may transition between the first and second positions as a result of the cam's 102 rotation. For example, FIG. 4A shows the cam 102 in a first rotational position that may correspond to the first position, and FIG. 4B shows the cam in a second rotational position that may correspond to the second position.

The active suspension system 100 may include a cam motor 104 that may be configured to selectively rotate the cam 102 between at least a first rotational position (e.g., FIG. 4A) and a second rotational position (e.g., FIG. 4B). In some embodiments, the one or more cam motors 104 may be disposed on the cleaning robot 50, such as within the wheel assembly 59 or otherwise. In some embodiments, the cam motor 104 may be mounted to the chassis 52 so as to resist rotation or other movement in reaction to rotational forces applied to the cam 102. In some embodiments, the cam motor 104 may be a stepper motor that may divide its motor rotations into a number of equal steps. In some embodiments, such a stepper motor's rotational position may be rotated and held at a particular known position without additional positional sensor feedback to determine positions of the cam. In some embodiments, other types of motors may be used consistent with the disclosure.

In some embodiments, the rotational forces generated by the one or more cam motors 104 may be translated to the cam 102 via a cam axle 106. In some embodiments, the cam axle 106 may pass through a portion of the chassis 52 and/or a cam collar 108. In some embodiments, the cam collar 108 may apply a clamping force to the chassis 52, thereby holding the cam 102 and cam motor 104 stationary with respect to the chassis 52. In some embodiments, the cam axle 106 may be received within an axle orifice 107 formed in the cam 102. The axle orifice 107 may be offset from the center of the cam 102 so as to define a varying radial distance between the cam axle 106 and the curved circumferential edge 109 of the cam.

The active suspension system 100 may also include a cam follower 110 that may be mounted or otherwise coupled to the arm 60 of the wheel assembly 59. In some embodiments, the cam follower 110 may be mounted on a top portion 66 of the arm 60 such that a contact surface 111 of the cam follower may be in slidable contact with the circumferential edge 109 of the cam 102. In some embodiments, the arm 60 and cam follower 110 may be biased against the cam 102 by a spring or other mechanism, or the weight of the chassis 52 connected to cam may bias the cam toward the contact surface 111. Accordingly, in some embodiments, as the cam 102 rotates about the cam axle 106, the circumferential edge 109 of the cam may slide along the contact surface 111 of the cam follower 110. In some embodiments, because of varying radial distance between the cam axle 106 and the cam edge 109, the cam 102 may push against the cam follower 110 as the cam rotates in a first rotational direction 114. Although the first rotational direction 114 is indicated as counterclockwise in FIG. 4A, those skilled in the art will understand that different configurations of the cam 102 and the active suspension system 100 may have similar results using different rotational directions within the scope of the disclosure.

In some embodiments, as the cam 102 rotates in the first rotational direction 114 with respect to the chassis 52, a cam distance 112 may increase. In some embodiments, the cam distance 112 may be defined as a radial distance between the cam axle 106 and the contact surface 111 of the cam follower 110. FIG. 4A shows a non-limiting example of a first rotational position of the cam 102 resulting in a first cam distance 112A. FIG. 4B shows a non-limiting example of a second rotational position of the cam 102 resulting in a second cam distance 112B. In some embodiments, moving the cam 102 between the first rotational position (FIG. 4A) and the second rotational position (FIG. 4B) may result in moving the arm 60 between a first position (FIG. 3A) of the active suspension system 100 corresponding to a first clearance height 68A and a second position (FIG. 3B) corresponding to a second clearance height 68B.

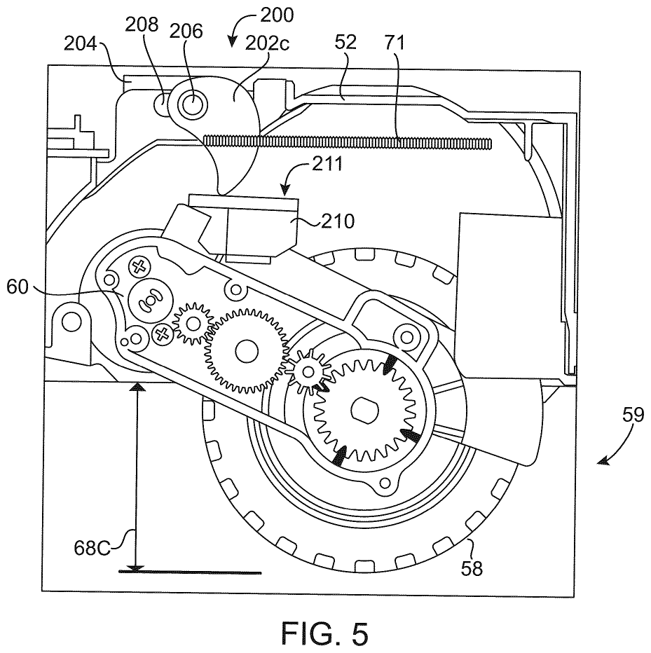

Those skilled in the art will recognize that the first and second cam positions and resulting in the first and second clearance heights are merely exemplary, and that virtually infinite rotational positions and respective clearance heights may be achieved using the principles of this disclosure. Additionally, it is contemplated that the illustrated shapes of the cam 102 cam follower 110 shown in FIGS. 3-4 are merely one example of a cam shape and that many other cam shapes may be used consistent with the scope of the disclosure. For example, FIG. 5 shows an embodiment of an active suspension system 200 that may include a cam follower 210 having a different shape than the cam follower 110 that may result in providing a different range of potential clearance heights 68C between the floor and the chassis 52. The active suspension system may include a cam motor 204 that may selective rotate the cam 202 by applying torque to a cam axle 206 that may be disposed through an axle orifice 207 in the cam 202. The cam follower 210 may have a larger vertical dimension than the cam follower 110 that may provide for varying clearance heights.

In some embodiments, one or more controllers, such as controller 74 shown in FIG. 2A, disposed on the wheel assembly 59, the chassis 52, or elsewhere may be in electronic communication with each cam motor 104 to provide instructions to alter the ride height of the cleaning robot 50 using the active suspension system 100. In some embodiments, the controller may determine a desired chassis clearance height 68 in response to sensory inputs from the cleaning robot's 50 sensors about robot's environment or characteristics of other robot components (e.g., current draw, rate of rotation, etc.). For example, the a 3D camera or other sensor may identify an obstacle on a target surface where the cleaning robot 50 is cleaning or otherwise traveling. The 3D camera may transmit visual data related to the obstacle to the controller (e.g., laser point cloud make up, etc.), and the controller may decipher the visual data to determine a height of the obstacle with respect to the floor or other target surface. Based on the determined height of the obstacle, the controller may determine a desired chassis clearance height 68 that may allow the robot 50 chassis 52 to clear the obstacle. In some embodiments, based on predetermined data for the active suspension system (e.g., reference tables), the controller may then determine what degree of cam rotation may result in the desired clearance height, if any. In response, the controller may transmit instructions to the active suspension system 100 (e.g., the cam motor 104) to apply the determined degree of cam rotation, thereby rotating the cam 102 to a rotational position that results in the desired clearance height. In some embodiments, this process may be iteratively repeated as additional obstacles are encountered and/or the robot 50 moves through its environment.

### Control of the Active Suspension System

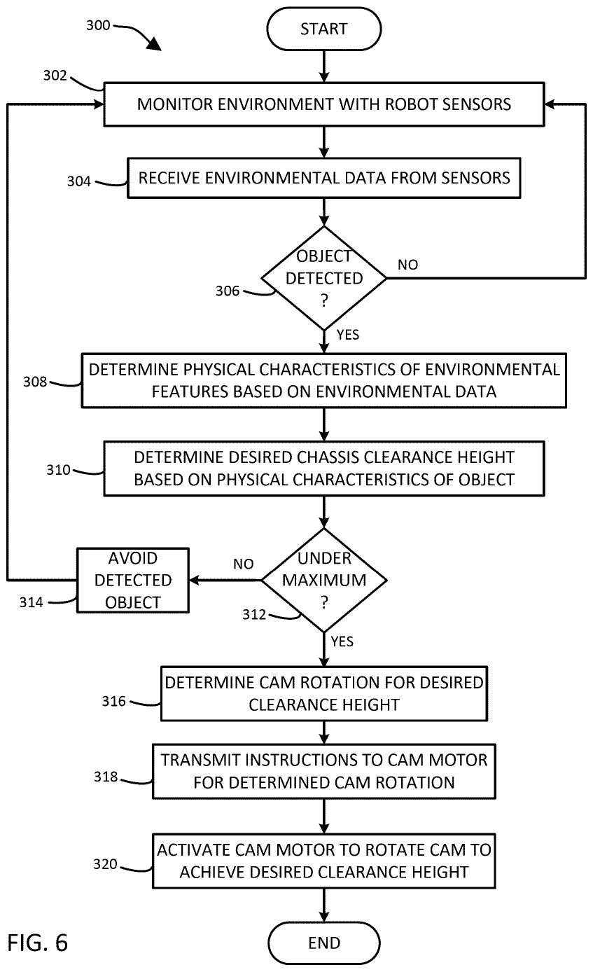

FIG. 6 is a flow chart of an embodiment of a method 300 of adjusting the ride height of the cleaning robot 50 based on sensed information about the robot's surroundings. At 302, the robot's sensors may monitor the robots surroundings, transmitting data to one or more controllers. At 304, the controller may receive the environmental data from the sensors and may analyze the data to determine whether any obstacles or other environmental objects have been found in the vicinity of the robot, in the robot's planned path of travel, on the target surface for cleaning, etc. At 306, if no object is detected, the sensors may continue monitoring the environment at 302. If an object is detected at 306, at 308, the controller may determine one or more physical characteristics and/or dimensions of the detected object, such as height, width, depth, etc., based on the environmental data. At 310, based on the determined physical dimensions (e.g., height) of the detected object, the controller may determine a desired chassis clearance height, such as by adding a predetermined buffer height to the detected object height or other suitable method.

At 312, the controller may determine whether the desired chassis clearance height is less than a maximum clearance height that may be particular to the physical capabilities and/or characteristics of the cleaning robot and the active suspension system. If the desired chassis clearance height is more than the maximum clearance height, at 314, the controller may determine that the robot should avoid the detected object or take other alternate action. If the desired chassis clearance height is less than the maximum clearance height, at 316, the controller may determine what cam motor output may be used to achieve the desired chassis clearance height. For example, in embodiments where the cam motor 104 may be a stepper motor, the controller may determine how many steps the motor should rotate to achieve the cam rotation appropriate to reach the desired chassis clearance height. In other embodiments, the active suspension system 100 may include a rotational encoder to provide feedback regarding how much rotation (e.g., degrees, radians, etc.) the cam motor may have rotated the cam axle, and the controller may determine how many degrees of rotation may be appropriate to achieve the desired chassis clearance height. In some embodiments, the information translating the desired chassis clearance height to the appropriate measure of motor input/output may be stored in a look-up table or other database available to the controller. At 318, the controller may transmit instructions to the cam motor and, at 320, the cam motor may be activated to rotate the cam the appropriate rotational degree determined to achieve the desired chassis clearance height.

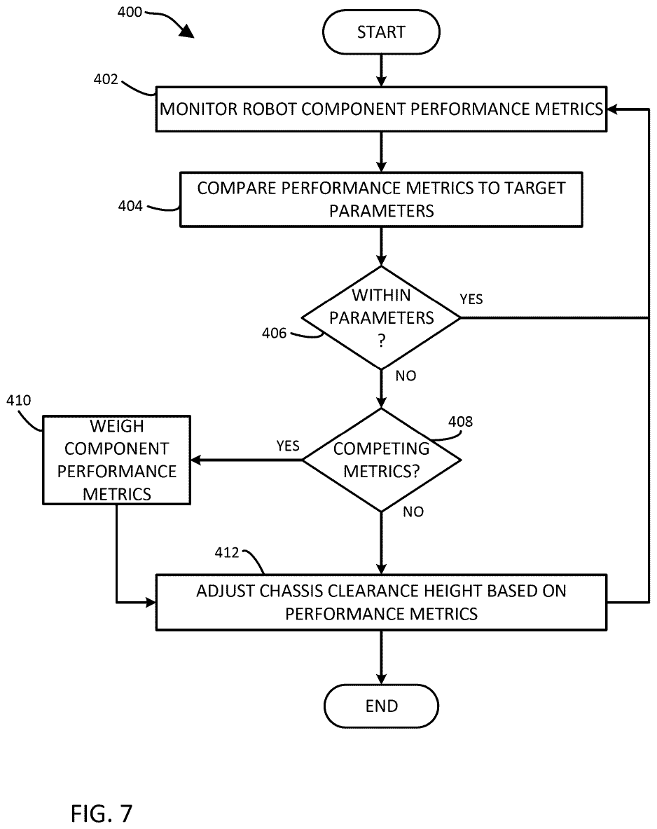

In some embodiments, the one or more controllers may receive feedback from other components of the cleaning robot and use that feedback as inputs for raising and/or lowering chassis 52 using the active suspension system 100. FIG. 7 is a flow chart showing an embodiment of a method 400 for raising/lowering the active suspension system 100 to maintain one or more predetermined cleaning robot performance metrics, such as suction level, brush rotation rate, etc. In some embodiments, such adjustments may provide for improved cleaning performance, power efficiency, battery life, etc. In some embodiments, the controller, such as controller 74, may be in electronic communication with cleaning robot 50 components such as suction motors, vacuum sensors, agitator brush rolls, etc. At 402, the method 400 may include monitoring performance metrics of one or more components of the cleaning robot 50. For example, the cleaning robot may monitor a brush roll speed for an agitator brush included in a vacuum module, the electrical current or power draw for the brush roll or other components, the seal and/or suction of the vacuum, etc. In some embodiments, the seal or suction of the vacuum may be monitored by one or more pressure sensors disposed in the vacuum module so as to be in fluid communication with a suction conduit. A relatively low pressure sensed by the one or more pressure sensors may correspond to a relatively high suction and/or better seal with the target surface. Accordingly, monitoring robot component performance metrics may include monitoring various component activity by a controller in electronic communication with those components or sensors measuring the performance of those components.

At 404, the method may include comparing the measured component performance metrics against target performance parameters for the particular component or measurement. For example, the system may store or determine an optimal brush roll rotation rate or range that may be vary based on characteristics of the target surface as may be determined by sensors (e.g., bare floor, low-pile carpet, high-pile carpet, etc.). In some embodiments, the system may store an optimal electrical current draw or power draw for a brush motor that may drive the rotation of the brush roll. In some embodiments, an excessive current draw may result from an obstruction or high-resistance characteristics of the target surface (e.g., high-pile carpet), and it may be desirable to reduce the friction level or the resistance level encountered by the brush roll by raising the chassis clearance height and thereby reduce the electrical current drawn by the brush motor to conserve power and/or help prevent damage to the brush motor or other components. In another example, the system may store or determine an optimal suction level or range of levels, which may vary based on target surface characteristics. In some embodiments, the system may also store an optimal current draw or range of current draw for the suction motor and alter the chassis clearance height to conserve power and/or help prevent damage to the motor. In some embodiments, the robot may continuously or periodically monitor the performance parameters while traversing a first type of surface (e.g., bare floor). When the robot detects that it has transitioned to a second surface (e.g., carpet) that is different than the first surface, either by detecting a sudden change in the monitored performance parameters or by using a sensors (e.g., an ultrasonic floor-type sensor, proximity sensors, optical sensors, sonar, LIDAR, infrared (IR) sensors, ultrasonic sensors, 2D and/or 3D cameras, photosensors, etc.) configured to detect the type of surface that the robot is traversing, the robot may adjust the robot's chassis clearance height to bring the performance parameters to match their values from the preceding floor type. In some embodiments, such a control method may help mitigate brush roll baseline currents changing over time as parts wear or debris accumulated around the brush.

At 406, if the measured performance metrics fall within the target parameters or within a predetermined margin of error, the method 400 may include continuing to monitor the robot component performance metrics. In some embodiments, if one or more performance metrics may be determined to fall outside the target parameters or range of parameters, the method 400 may include, at 408, determining whether the off-target metrics are competing metrics. In some embodiments, competing metrics may be performance metrics for which actions to bring one of the competing performance metrics to within the target parameters may bring another of the competing performance metrics further from its target parameter. For example, in some embodiments, the controller may determine that the brush roll rotation rate may be lower than the target parameter, which may indicate that controller should instruct the active suspension system 100 raise the chassis clearance height (and therefore the brush roll) to reduce the resistance encountered by the brush roll and increase the brush roll rotation rate. At the same time, the controller may determine that the suction level may be lower than its target parameter, which may indicate that the controller should instruct the active suspension system 100 to lower the chassis clearance height to improve the vacuum seal and increase the suction level. Because the remediating action (e.g., raising or lowering the chassis clearance height) to improve one performance metric may worsen another performance metric, those performance metrics may be considered as competing metrics. If no competing metrics are present at 408, the controller may, at 412, instruct the active suspension system 100 to raise/lower the wheels to adjust the chassis clearance height based on the performance metrics. For example, if the current draw for the brush roll motor is determined to be higher than its respective target parameter, the controller may instruct the active suspension system to raise the chassis clearance height, which may thereby reduce the resistance encountered by the brush roll and reduce the current draw of the brush roll motor.

If, at 408, competing metrics are present, at 410, in some embodiments, the controller may weigh the competing metrics to determine which, if any, of the off-target parameters should be addressed. In some embodiments, the weighing of different component performance metrics may be predetermined for any given scenario. For example, in some embodiments, maintaining a target current draw for the brush roll motor may be more heavily weighted (i.e., more important) than maintaining optimal vacuum suction (or vice versa). In some embodiments, the weighting of different performance metrics may vary situationally based on various factors, such as remaining battery life, programing mode, flooring characteristics, user preferences, load levels over time, time duration of off-target metrics, etc. Once the controller has determined the more heavily weighted performance metric for a given situation, the controller may, at 412, instruct the active suspension system 100 to raise/lower the wheels to adjust the chassis clearance height based on the performance metrics. Those skilled in the art will recognize that the method 400 may be performed iteratively in either a continuous fashion or at predetermined intervals so that the active suspension system may make near-constant adjustments in an effort to optimize the cleaning robot's performance and/or efficiency.

### Other Active Suspension System Configurations

While the embodiments of the active suspension system 100 shown and described with reference to FIGS. 2-4 are described as including one or more rotatable cams each driven by a cam motor, other embodiments are contemplated herein to achieve the goal of adjusting the chassis clearance height of the cleaning robot 50 and/or for setting a hard stop representing a limit for travel of a suspension system. In each embodiment of the active suspension system disclosed herein, it is contemplated that similar feedback/control relationships may exist between robot sensors, one or more controllers, and the active suspension system regardless of the specific components making up each particular embodiment of the active suspension system.

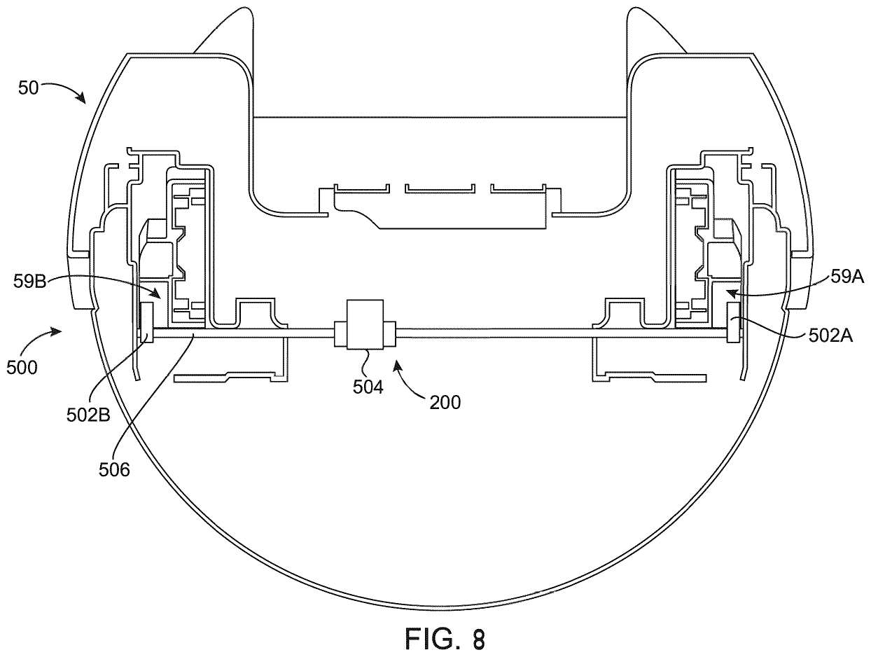

FIG. 8 shows an embodiment of an active suspension system 500 that may include a single cam motor 504. In such an embodiment, a the cam motor 504 may be mounted to the chassis 52 and may be configured to selectively rotate a cam axle 506 that may be coupled to multiple cams 502A, 502B. For example, in some embodiments, a first cam 502A may disposed on a first end of the cam axle 506 and configured to actuate the wheel assembly 59A, and a second cam 502B may be disposed on a second end of the cam axle and configured to actuate the wheel assembly 59B. In some embodiments, the cam axle 506 may include multiple segments that may transfer rotational torque to one another via one or more gears or gear trains.

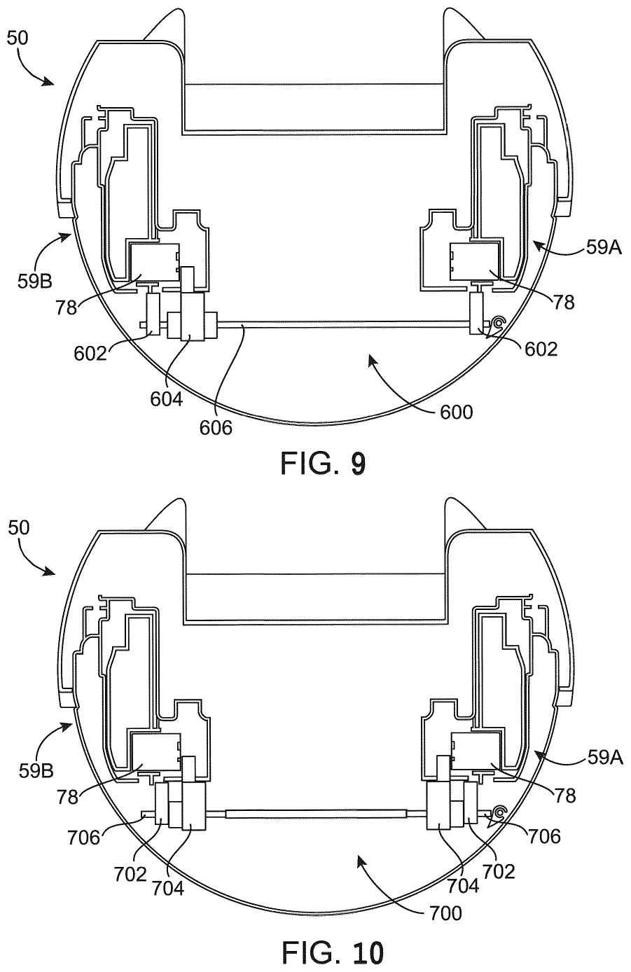

FIG. 9 shows an embodiment of an active suspension system 600 that may divert power from one or more drive motors 78 to power rotation of one or more cams 602. For example, in some embodiments, a clutch 604 may be configured to selectively utilize power or rotational torque generated by the drive motors 78 that may also be configured to drive the wheels of the cleaning robot 50. The clutch 604 may disengage from a cam axle 606 when no cam rotation may be needed, and my reengage with the cam axle when the controller determines that the active suspension system is needed to adjust the chassis clearance height. FIG. 10 shows another embodiment of an active suspension system 700 that may divert power from multiple drive motors 78 to power rotation of one or more cams 702. Such as system 700 may include multiple clutches 704 that may divert power from multiple drive motors 78. Each clutch 704 may be configured to selectively utilize power or rotational torque generated by the drive motors 78 that may also be configured to drive the wheels of the cleaning robot 50. Each clutch 704 may disengage from a respective cam axle 706 when no cam rotation may be needed, and my reengage with the respective cam axle when the controller determines that the active suspension system is needed to adjust the chassis clearance height.

The cleaning robot 50 may also may alternatively or additionally include other embodiments of the active suspension system that may be utilized consistent with the disclosure. For example, in some embodiments, the robot 50 may include a magnetorheological damper system included on one or more cams. The dampers may be filled with magnetorheological fluid, which may be a mixture of easily magnetized iron particles in a synthetic hydrocarbon oil. In some embodiments, one or more dampener tubes may be included on each cam. Each of the monotube dampers may include a piston containing two electromagnetic coils and two small fluid passages through the piston. The electromagnets may be configured to create a variable magnetic field across the fluid passages. When the magnets are off, the fluid may travel through the passages freely. When the magnets are turned on, the iron particles in the fluid may create a fibrous structure through the passages in the same direction as the magnetic field. The strength of the bonds between the magnetized iron particles may cause the effective viscosity of the fluid to increase, resulting in a stiffer suspension in the wheel assemblies. In some embodiments, the stiffer suspension may establish a hard stop for the robot's passive suspension system. In some embodiments, altering the strength of the current may result in an instantaneous change in force of the piston. If the sensors sense any body roll or change in surface, they may communicate the information to an electrical control unit (ECU). The ECU may compensate for this by changing the strength of the current to the appropriate dampers.

In some embodiments, instead of or in addition to the cam systems described herein, the active suspension system may use a rack and pinion system to move the wheels toward and/or away from the chassis, thereby raising and/or lowering the chassis with respect to the target surface. The rack and pinion may include a rotating gear configured to be rotated by one or more motors, and may include a pinion disposed on the arm of the wheel assembly to transmit the rotational input of the motor to a linear vertical movement of the arm and/or corresponding wheel.

In some embodiments, a linear actuator may be used instead of or in addition to the cam systems described herein. In such a system, a motor for the linear actuator may be mounted to the chassis of the robotic cleaner and an actuatable arm may contact the arm of the wheel assembly. The linear actuation may move the arm and/or wheel away from the chassis, raising the chassis further from the target surface.

In some embodiments, the one or more caster wheels, such as caster wheel may also be vertically adjustable by a cam system, a rack and pinion system, corkscrew lift, or another suitable lifting/lowering mechanism. In some embodiments, the caster wheel may be configured to be raised and/or lowered in conjunction with the driven wheels in the wheel assemblies via a drive train and/or gear trains transmitting the rotational torque supplied by the cam motor to a similar cam system corresponding to the caster wheel. In some embodiments, an independent cam motor, linear actuator, or other motor may be disposed on the chassis to vertically adjust the caster wheel in a similar manner to that described herein with respect to the driven wheels.

### Active Suspension to Optimize Vacuum Effectiveness

Cleaning effectiveness of the robot 50 may be determined by an orientation of the robot 50 in relation to a cleaning surface. For example, when a first side of the robot 50 is farther away from the cleaning surface than a second side (e.g., the robot 50 is tilted in relation to the floor), vacuum strength and roller or mop pressure is reduced on the first side, thus also reducing cleaning effectiveness for the first side.

One solution senses friction or load changes in the driving wheels of the robot. This solution includes auxiliary wheels positioned forward and rearward of the driving wheels. For example, when a forward auxiliary wheel drives on top of an obstacle, the robot will tilt rearward. When the tilt causes the rearward auxiliary wheels to contact the cleaning surface, friction or load on the driving wheels is reduced. This friction/load reduction causes the robot to extend its driving wheels until normal/horizontal friction/load on the driving wheels is restored, thus keeping the robot level with the cleaning surface (see U.S. Pat. No. 9,775,476).

Another solution relies on sensors and a controller to determine a robot “stuck state” when one or more of the driving wheels is lifted so that it does not contact the cleaning surface. For example, position, tilt, and current sensors may send data to the controller indicating a driving wheel has lost contact with the cleaning surface. In response to threshold exceeding sensor data, the controller instructs a motor to extend the lifted wheel to restore contact. The threshold for extending the driving wheel is based on clearance measurements for the underside of the robot (see U.S. Pat. No. 9,950,586).

The addition of auxiliary wheels with pressure or contact sensors as in U.S. Pat. No. 9,775,476 is costly and adds an additional point of possible failure (i.e., the auxiliary wheel pressure/contact sensor). Likewise, reliance on wheel slip measurements as described in U.S. Pat. No. 9,950,586 does not account for losses in cleaning effectiveness due to robot tilt.

In some embodiments, the cleaning robot, such as via the controller and one or more sensors, may detect a tilt position and use the active suspension system to maintain level clearance of the robot underside to the cleaning surface and maintain cleaning effectiveness. For example, a tilt sensor or other sensor detects the tilt angle of the cleaning robot and determines that it exceeds an angle by which the robot maintains effective cleaning (i.e., vacuum suction, brush or pad contact, etc.). The robot may also detect that one or more wheels may be spinning with more or less resistance as compared to the resistance encountered while driving. In some embodiments, the wheel resistance may be determined by monitoring the electrical current levels of the one or more drive motors. For example, when current levels for one or more drive motors drop below a threshold current level, it may indicate that the wheel may be slipping on the target surface or may be clear of the surface altogether.

In further embodiments, the cleaning robot, such as via the controller and an optical sensor, may detect a tilt position and use the active suspension system to maintain level clearance of the robot underside to the cleaning surface. As described above in reference to FIGS. 3A, 3B, the controller may determine a desired chassis clearance height 68A, 68B in response to sensory inputs from the cleaning robot's 50 sensors about robot's environment or characteristics of other robot components (e.g., current draw, rate of rotation, etc.). For example, the a 3D camera or other sensor may identify an obstacle on a target surface where the cleaning robot 50 is cleaning or otherwise traveling. The 3D camera may transmit visual data related to the obstacle and/or target surface to the controller (e.g., laser point cloud make up, etc.), and the controller may decipher the visual data to determine an orientation of the obstacle or an orientation of the robot 50 with respect to the floor, or other target surface. For example, the laser point cloud may indicate that the robot 50 is tilted with respect to the target surface and, thus, is not providing maximum cleaning effectiveness or at least uneven cleaning. Based on the determined orientation of the obstacle and/or the robot 50, the controller may determine a desired chassis clearance height 68 to extend or retract each driving wheel 58 independently and allow the robot 50 chassis 52 to remain horizontally level throughout the cleaning process. Similarly, based on the orientation of the obstacle and/or robot, the controller may determine an amount to extend or retract one or more of the wheels to maintain a horizontally level chassis clearance height 68 for the effective cleaning area of the vacuum, brush, or mop surface of the robot 50.

In combination with predetermined data for the active suspension system (e.g., reference tables), the controller may use the tilt data described above to then determine what degree of cam rotation may result in a horizontally level orientation for the robot 50. In response, the controller may transmit instructions to the active suspension system 100 (e.g., the cam motor 104) to apply the determined degree of cam rotation, thereby rotating the cam 102 to a rotational position that results in the horizontally level orientation. In some embodiments, this process may be iteratively repeated as additional tilting obstacles or uneven surfaces are encountered and/or the robot 50 moves through its environment.

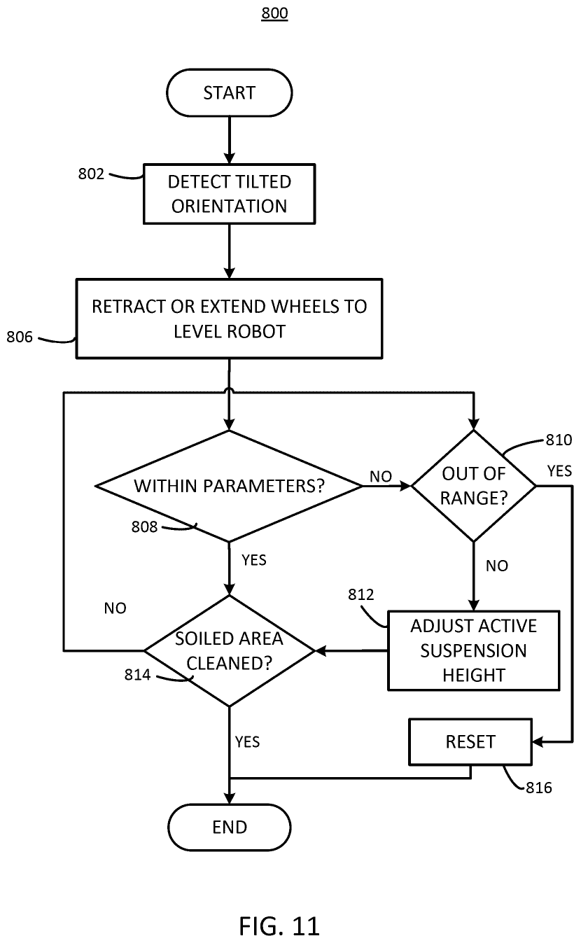

FIG. 11 shows a flow chart of an embodiment of a method 800 of using the active suspension system to maintain a horizontally level orientation for the robot 50. Each step of the method 800 is one or more processor-executable instructions (e.g., control signals, modules, blocks, stand-alone instructions, etc.) stored in a computer memory and executed on a processor of the cleaning robot or other computing device which may be physically configured to execute the different aspects of the method 800.

At 502, sensors on the cleaning robot may identify and the controller may determine a tilted orientation of the robot 50 with respect to a target surface for cleaning. In some embodiments, detection of the tilted orientation may include using a plurality of laser lines and construction of a point cloud of laser returns from the target surface for cleaning. At 806, the active suspension system may retract or extend one or more of the wheels of the cleaning robot to bring it to a level orientation with respect to the target surface. The level orientation may be confirmed by construction of one or more point clouds of laser returns from the target surface for cleaning. At 808, the controller may determine, based on inputs from sensors or through other suitable methods, whether certain predetermined parameters may be within desired or optimal ranges. A laser point cloud of the target surface may indicate both the orientation (i.e., tilted, level, direction, etc.) and clearance to the target cleaning surface for the robot 50 to optimize cleaning effectiveness. If, at 808, the detected parameters are not within effective cleaning ranges, and, at 810, the active suspension system has not extended or retracted the one or more wheels to their limit, the active suspension system may adjust the suspension and/or one or more wheel heights in a direction that may bring the detected parameter nearer to or into the preferred optimal range at 812. For example, if the clearance to the target cleaning surface is greater than an effective distance for the vacuum, brush, or pad, then the active suspension system may retract one or both wheels to increase the suction force or brush/pad force.

After levelling the robot 50 at and cleaning the surface, the cleaning robot may determine, such as using sensors, whether the target surface has been adequately cleaned at 814. If not, then the method may return to 810. If the active suspension system has not extended or retracted the one or more wheels to their limit, the active suspension system may, again, adjust the suspension and/or one or more wheel heights in a direction that may bring the detected parameter nearer to or into the preferred optimal range at 812. If the active suspension system has extended or retracted the one or more wheels to their limit, the robot 50 may reset at 516 and execute actions to avoid the target surface. If the target surface is adequately cleaned, then the method 500 may end.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A robotic cleaner for optimizing suction with a target surface by independently adjusting one or more ride height dimensions with respect to the target surface, the robotic cleaner comprising:
a chassis including an upper portion and a lower portion;
one or more wheel assemblies disposed on the lower portion of the chassis, each of the one or more wheel assemblies including:
an arm having a first end pivotally mounted to the chassis and a second end opposite the first end;
a wheel rotatably coupled to the second end of the arm, the wheel configured to contact a target surface;
one or more sensors configured to sense characteristics of the robotic cleaner's surroundings; and
an active suspension system configured to rotate the arm about the first end in response to the sensed characteristics of the robotic cleaner's surroundings to adjust one or more ride height dimensions.

2. The robotic cleaner of claim 1, wherein the one or more sensors are further configured to determine a type of the target surface.

3. The robotic cleaner of claim 2, wherein the type of the target surface corresponds to an electrical current draw of a brush motor of the robotic cleaner.

4. The robotic cleaner of claim 3, wherein the brush motor drives a brush roll in contact with the target surface.

5. The robotic cleaner of claim 4, wherein the active suspension system is further configured to adjust the one or more ride height dimensions based on the electrical current draw of the brush motor of the robotic cleaner.

6. The robotic cleaner of claim 1, wherein the characteristics of the robotic cleaner's surroundings include a physical dimension of an object in the robotic cleaner's surroundings.

7. The robotic cleaner of claim 6, wherein the physical dimension of the object includes a height of the object and the active suspension system is further configured to rotate the arm about the first end in response to the height of the object.

8. A robotic cleaner for optimizing suction with a target surface by independently adjusting one or more ride height dimensions with respect to the target surface, the robotic cleaner comprising:
a plurality of wheel assemblies each including:
an arm having a first end pivotally mounted to a chassis of the robotic cleaning device and a second end opposite the first end;
a wheel rotatably coupled to the second end of the arm, the wheel configured to contact the target surface;
a cam in slidable contact with the arm; and
a cam motor mounted to the chassis of the robotic cleaning device, the cam motor configured to selectively rotate the cam in response to one or more dimensions of the target surface;
wherein each of the plurality of wheel assemblies is configured to independently activate a respective cam motor to push a respective second end of the respective arm away from the chassis in response to the one or more dimensions of the target surface.

9. The robotic cleaner of claim 8, further comprising one or more sensors configured to sense one or more characteristics of the target surface.

10. The robotic cleaner of claim 9, wherein the one or more sensors are further configured to receive one or more of an electrical current draw of a brush motor of the robotic cleaner and one or more physical dimensions of an object corresponding to the target surface.

11. The robotic cleaner of claim 10, wherein the brush motor drives a brush roll in contact with the target surface.

12. The robotic cleaner of claim 11, wherein the each of the plurality of wheel assemblies is further configured to independently activate its respective cam motor to adjust the one or more ride height dimensions based on the one or more physical dimensions of the object corresponding to the target surface.

13. The robotic cleaner of claim 12, wherein the one or more physical dimensions of the object corresponding to the target surface includes a height of the object with respect to the target surface.

14. The robotic cleaner of claim 13, wherein each of the plurality of wheel assemblies is further configured to rotate its cam in response to the height of the object with respect to the target surface.

15. A processor-implemented method of optimizing suction for a robotic cleaning device with respect to a target surface by independently adjusting one or more ride height dimensions of the robotic cleaning device, the method comprising processor-executable instructions for:
sensing, via one or more sensors, one or more characteristics of an environment surrounding the robotic cleaning device;
identifying, via one or more processors and based on the one or more sensed characteristics, an object in the environment;
determining, via the one or more processors, that the object is located in a path of the robotic cleaning device;
determining, via the one or more processors and based on the sensed one or more characteristics, at least one dimension of the object; and
activating an active suspension system of the robotic cleaning device to raise the distance between a chassis of the robotic cleaning device and the target surface based on the determined at least one dimension.

16. The processor-implemented method of claim 15, wherein the one or more sensed characteristics includes one or more of a height, a width, and a depth of the object.

17. The processor-implemented method of claim 15, further comprising determining a chassis clearance height based on the one or more sensed characteristics.

18. The processor-implemented method of claim 15, wherein activating the active suspension system of the robotic cleaning device includes determining a cam motor output based on the determined at least one dimension.

19. The processor-implemented method of claim 18, wherein a rotational encoder of a cam motor receives the cam motor output to activate the active suspension system.

20. The processor-implemented method of claim 18, wherein a pressure sensor in fluid communication with a suction conduit of the robotic cleaning device confirms optimal suction for the robotic cleaning device with respect to the target surface.
